(19) United States
(12) Patent Application Publication
(10) Pub. No.: US 2011/0229644 A1
(43) Pub. Date: Sep. 22, 2011

(54) GLASS COATING PROCESS AND APPARATUS

(75) Inventors: Markku Rajala, Vantaa (FI); Erkki Seppalainen, Vantaa (FI); Toni Korelin, Helsinki (FI)

(73) Assignee: BENEQ OY, Vantaa (FI)

(21) Appl. No.: 13/130,469

(22) PCT Filed: Dec. 21, 2009
(86) PCT No.: PCT/FI2009/051022

§ 371 Date: May 20, 2011

(30) Foreign Application Priority Data
Dec. 23, 2008 (FI) 20080675

(51) Int. Cl. B05D 3/02; B05C 13/02

(52) U.S. Cl. 427/314; 118/66

(57) ABSTRACT

A process and an apparatus for coating glass substrate by using at least one or more liquid raw materials which react essentially on or in the vicinity of at least a portion of the glass substrate surface. The process comprises steps: a) heating the glass substrate to at least substantially the coating temperature; b) forming a coating on the glass substrate surface by converting the one or more liquid materials to a liquid-aerosol and depositing at least a fraction of the liquid-aerosol on the glass substrate surface; c) repeating step b) at least once; and d) heating the glass substrate surface before at least one of the steps b). The heating in step d) is carried out by convective heating.

### FIELD OF INVENTION

The present invention relates to a process for coating on a glass substrate according to the preamble of claim 1 and specifically to a process for coating glass substrate by using at least one or more liquid raw materials which react essentially on or in the vicinity of at least a portion of the glass substrate surface forming a coating on it, the process comprising steps: a) heating the glass substrate to at least substantially the coating temperature; b) forming a coating on the glass substrate surface by converting the one or more liquid materials to a liquid aerosol and depositing at least a fraction of the liquid-aerosol on the said portion of the glass substrate surface; c) repeating step b) at least once; and d) heating the glass substrate surface before at least one of the steps b). The present invention further relates to an apparatus for forming a coating on a glass substrate according to the preamble of claim 14 and specifically to an apparatus for pyrolytically forming a coating on a glass substrate, the apparatus comprising: conveyor means for conveying the glass substrate in a down-stream direction along a coating path; at least two coating units arranged successively along the coating path for converting one more liquid materials to liquid-aerosol and spraying the liquid-aerosol on the glass substrate to form a coating on the glass substrate; glass substrate heating means for heating the glass substrate to substantially at least the coating temperature annealing temperature of the glass substrate before forming the coating; and one or more glass substrate surface heating means for heating the glass substrate surface.

### BACKGROUND OF THE INVENTION

Coated glass is manufactured for various purposes, the coating being selected to confer some particular desired property of the glass. Important examples of coatings for architectural and automotive glass are those designed to reduce the emissivity of the coated face in respect to infrared radiation (low-e coatings), coatings designed to reduce the total solar energy transmittance and coatings designed to provide a hydrophilic or self-cleaning glass surface. For photovoltaic applications glasses with transparent conductive oxide (TCO) coatings are very important. It is known that for example fluorine doped tin oxide (FTO) or aluminum doped zinc oxide coatings serve well for TCO and low-e coatings, titanium oxide coatings, especially with anatase crystal structure serve for self-cleaning coatings and iron-cobalt-chrome-based oxide coatings serve for near-infrared reflection coatings.

Coatings on glass can be divided into two different groups, soft coatings and hard coatings. Soft coatings are typically applied by sputtering and their adhesion to the glass surface is rather poor. Hard coatings which typically have an outstanding adhesion and high abrasion resistance are typically applied by pyrolytic methods, such as chemical vapor deposition (CVD) and spray-pyrolysis.

In CVD the coating precursor material is in vapor phase and the vapor is caused to enter a coating chamber and flow as a well controlled and uniform current with the substrate being coated. The coating formation rate is rather slow and thus the process is typically carried out at temperatures exceeding 650° C., as the coating growth rates typically increases exponentially as the temperature is raised. The rather high temperature requirement makes CVD-process rather unsuitable for glass coating operations made outside the float glass process, i.e. for off-line coating applications.

In order to form thick coatings, typically coatings with thickness higher than 400 nm, at temperatures lower than approximately 650° C., it is conventional to use a spray coating apparatus for spraying a stream of droplets of coating precursor solution on the substrate. The conventional spray pyrolysis system, however, suffers from a number of disadvantages such as the generation of steep thermal gradients and problems with the coating uniformity and quality. A great improvement to the process can be achieved by decreasing the size of the droplets as described in the applicant's currently non-public Finnish patent applications FI20071003 and FI20080217.

The coating formation process is an Arrhenius-type function of the surface temperature and thus high glass surface temperatures are required for fast coating growth rate. U.S. Pat. No. 5,124,180, BTU Engineering Corporation, Jun. 23, 1992, describes a method for producing a substantially haze free fluorine doped metallic oxide coating on a substrate comprising the steps of: heating a surface of the substrate, contacting said surface with a vapor comprising: a metal oxide precursor, an oxygen containing agent, a dopant containing a vinylic fluorine and thermally reacting said vapor into a fluorine containing metal oxide. The publication also describes an apparatus for producing a uniform metal oxide thin film coating on a substrate. The apparatus includes a heater to heat the substrate to between approximately 450° C. and 600° C. and a conveyor to convey the heated substrate to a reaction zone adjacent an injector head. Thus, in reality, the whole substrate is heated, not only the substrate surface. The heating mechanism is not described, but FIG. 1A of the publication, shows a heater placed under the conveying substrates.

U.S. Pat. No. 4,917,717, Glaverbel, Apr. 17, 1990, describes an apparatus for pyrolytically forming a metal compound coating on an upper face of a hot glass substrate. The apparatus includes means for spraying the liquid raw material and heating means for supplying heat to the spraying zone. The spraying zone of the coating chamber is heated to cause evaporation of part of the coating precursor material before it reaches the substrate to charge the atmosphere in that zone with vaporized coating precursor material.

Liquid-aerosol-based coatings, i.e. coatings where the precursor material includes both gas and liquid droplets generally require more heat than vapor-based coatings due to the energy needed for liquid evaporation. Spray-coatings, where the liquid droplets are large, typically with a diameter around 100 micrometers require so much evaporation energy that the spray-coatings process cannot usually be applied in high-speed processes like float-glass production or glass tempering.

During the coating process the glass surface is cooled. The cooling effect has to be compensated for effective multi-stage coating. In order to avoid glass deformation the glass should be only heated from its surface. U.S. Pat. No. 4,655,810, Glaverbel, Apr. 7, 1987, describes heating the surface layer of the glass by exposing the surface to one or more radiant heaters having black body temperature below 1100° C. A similar heating solution is also described in the U.S. Pat. No. 4,536,204, Glaverbel, Aug. 20, 1985. It is well known to a person skilled in the art that soda-lime glass has a high transparency for wavelengths smaller than 2.5 micrometers. Thus, efficient radiant heaters which only heat the surface layer of glass must work at wavelengths higher than this, i.e at temperatures below 900° C. The coating process is frequently carried out at temperatures around 600° C. Thus the net heating power is lower than about 70 kW/m².

Radiative heating cannot be used when transparent conductive oxide (TCO) coatings are produced, because the coating reflects the infrared light and thus the glass surface is not effectively heated.

UK patent application GB 2 016 444 A, Saint-Gobain Industries, 26 Sep., 1979, describes adjusting the surface temperature of glass by means of a flame which sweeps the glass surface leaving the float furnace. Such heating cannot be used with glasses having a coating on them, because the stability temperature of the coatings is below the flame temperature.

It is preferable to make the pyrolytic coating on-line during the float manufacturing process or in high-speed off-line coating systems. In such lines the glass speed is typically between 5 m/min and 50 m/min. Thin coatings are often required, i.e. the coating thickness for a high-efficiency TCO coating on glass for photovoltaic (PV) applications may be about 1 micrometer. In various cases multiple coatings may be required, i.e. the coating stack for the PV application may comprise two underlayers and several TCO layers. Producing such coatings requires multi-stage, high-speed heating of the glass surface, which may include a coating layer. Such heating cannot be carried out by radiative heating only.

Accordingly the problem with the prior art multi-stage liquid-aerosol coating processes and apparatuses is that the liquid-aerosol sprayed on the surface of the glass cools the glass surface deteriorating the following coating stages. The prior art heaters and heating methods are inefficient for heating the glass surface in pyrolytic coating carried out on-line during float glass manufacturing process or in high-speed off-line coating systems and methods in which the glass speed is typically between 5 m/min and 50 m/min. Thus there is a need for a better liquid-aerosol-based coating process and apparatus capable for high-speed coating formation, including glass surface heating.

### BRIEF DESCRIPTION OF THE INVENTION

An object of the present invention to provide a process and an apparatus so as to overcome the above prior art problems. The objects of the invention are achieved by a process according to the characterizing portion of claim 1 and specifically by a process in which the glass substrate surface heating is carried out by convective heating. The objects of the present invention are further achieved by an apparatus according to the characterizing portion of claim 14 and specifically by an apparatus in which the glass substrate surface heating means are arranged to supply the heat energy to the substrate surface by convection.

The preferred embodiments of the invention are disclosed in the dependent claims.

The main purpose of the present invention is to introduce a process to be used in coating glass, especially in coating glass by liquid-aerosol-based method, by means of which process it is possible to produce uniform coatings at high coating growth rate. Another feature of the invention is an apparatus for producing a uniform coating on glass at high coating growth rate. The purpose of the invention is attained by a process using at least liquid raw materials which react essentially on at least a portion of the glass surface forming a coating on it, in which process the surface of the hot glass substrate, i.e. a glass substrate with a coating temperature or with a temperature higher than the annealing point of said glass, is heated above or to the temperature of the glass body. Such heating is preferably carried out by convection as convection essentially heats the glass surface and glass body is only heated by conduction and radiation of heat from the glass surface, and thus the glass body heats much more slowly than the glass surface. The liquid raw materials are converted to a mixture of droplets and gas, i.e. to a liquid-aerosol. The aerosol is deposited at least on a portion of the heated glass surface, where the raw materials react and form a coating. The present invention is limited to any particular coating formation mechanism. The coating mechanism may for example be implemented such that the droplets may evaporate in the gas phase before hitting the glass surface and the coating formation is carried out from the gas phase. The coating formation may be carried out in two or more phases, including repeating glass surface heating and aerosol deposition. It is obvious that the first step may also be a deposition of aerosol on a heated glass substrate after which at least one surface heating-aerosol deposition cycle is carried out. Alternatively the coating is formed from an liquid-aerosol depositing on the glass substrate, the raw materials in the liquid-aerosol reacting substantially on the glass surface so that a coating is formed on the glass substrate, in which process the glass surface is heated essentially just before the liquid-aerosol is deposited on the surface.

Glass surface heating makes it possible to apply surface temperatures above the temperature where the glass is so soft that it may bend, attach to the conveyor rollers or otherwise be formed in such way that the optical or other properties of the glass substrate impair. Essentially immediately after the glass surface heating process, a liquid-aerosol is deposited on the glass surface. The glass surface is cooled by convection caused by the spray, liquid evaporation and coating formation and thus essentially the same heat amount which was put in the glass by convective heating is taken out by the liquid-aerosol deposition and coating formation. This means that the glass body and especially the opposite surface of the glass body does not heat up significantly and the properties of the glass substrate do not essentially impair. For a typical float-process soda-lime glass the glass surface is heated by convection to at least 600° C., preferably to at least 700° C.

Glass surface can be effectively heated (or cooled) by applying convection. In this context, convection is defined as heat transfer by a flow of any gas. Gas may consist of several different gas and it may contain vapor, e.g. water vapor. A preferable way of forming a gas mixture for convective heating is to use a burner to combust either a solid, liquid or gaseous fuel and use the combustion gases for convective heating. When glass is heated, the heat is transferred to the glass surface by means of the gas flow. The heat then penetrates the glass through conduction and radiation.

When heat is transferred by convection, the efficiency of the process depends mainly on the momentum of the gas flow and the temperature difference between the glass and the gas. The term ‘forced convection’ is often used for intentional convective heating to separate it from natural convection caused by e.g. air currents. It is advantageous to use forced convection for heating the glass surface, the most preferable way being using impinging gas jets.

Convective heat transfer is described by the equation W/A=h(T_{g}−Tₛ) where h is the heat transfer coefficient (W/m²K), T_{g} is the temperature of the heating gas and Tₛ is the temperature of the surface. For efficient heating the heat transfer W/A should be higher than 10 kW/m², more preferable higher than 50 kW/m² and most preferable higher than 100 kW/m². Obviously there are two alternatives to adjust the heat transfer coefficient: either adjusting the heat transfer coefficient h or adjusting the gas-surface temperature difference. From a practical point of view it is preferable to use as high heat transfer coefficient h as possible. By using impinging, high velocity jets the heat transfer coefficient can be increased preferably to more than 100 W/m²K, more preferably to more than 300 W/m²k and most preferably to more than 500 W/m²K. The liquid raw materials are atomized and mixed with gas and thus a liquid-aerosol is formed. A two-fluid atomizer, where the liquid is atomized by a high-velocity gas flow, is a preferable method for atomization, because an aerosol with a good droplet density can be formed in a single step. For a fast evaporation of the droplets it is advantageous that the liquid is atomized to small droplets, preferably to droplets having a monomodal droplet size distribution and a mean droplet size of 10 micrometers or less.

The advantage of the present invention is that it enables efficient heating of the glass surface in an on-line during float glass manufacturing process or in high-speed off-line coating systems and methods in which the glass speed is typically between 5 m/min and 50 m/min.

### BRIEF DESCRIPTION OF THE DRAWINGS

In the following, the invention will be described in more detail with reference to the appended principle drawing, in which

FIG. 1 shows an embodiment of an apparatus according to the present invention for formation of a coating in the float glass process.

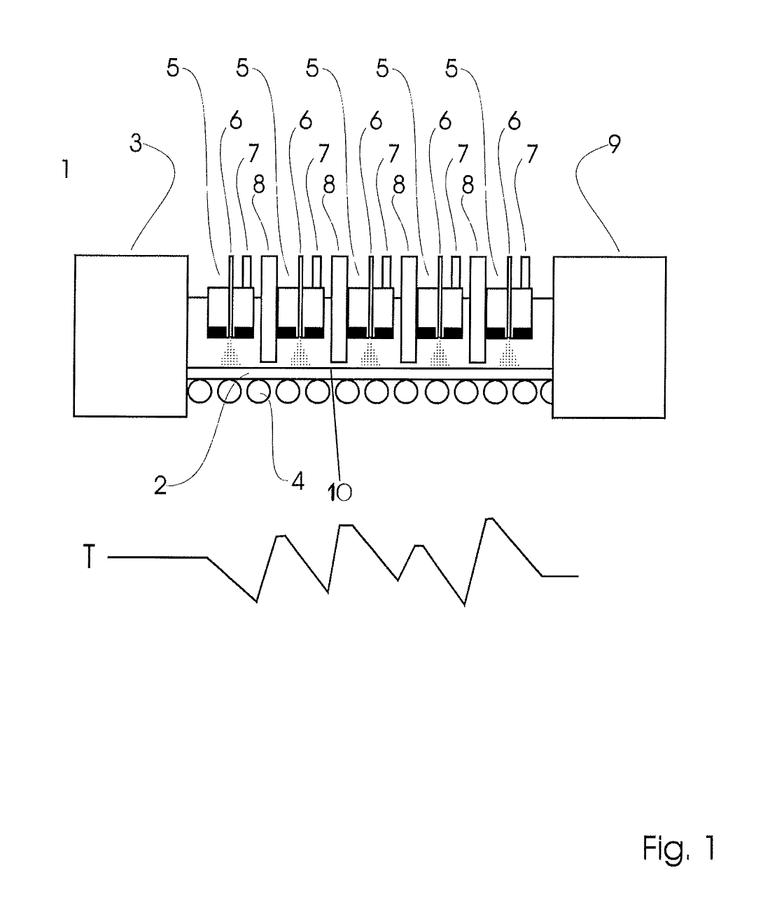

For the sake of clarity, the FIG. 1 only shows the details necessary for understanding the invention. The structures and details which are not necessary for understanding the invention and which are obvious for a person skilled in the art have been omitted from the FIGURE in order to emphasize the characteristics of the invention.

### DETAILED DESCRIPTION OF THE INVENTION

According to the invention a process for producing a coating on a hot glass substrate surface uses at least one or more liquid raw materials which react essentially on at least a portion of the glass substrate surface forming a coating on it, in which process the surface of the glass hot glass substrate, i.e. a glass substrate with a temperature higher than the annealing point of said glass substrate, is heated above the temperature of the glass body. In other words the glass substrate surface is heated to a higher temperature than the glass substrate. The glass substrate surface means in this context the surface or a surface layer of the glass substrate.

FIG. 1 shows, in principle, an embodiment where an apparatus 1 is used to form a pyrolytic coating on a glass ribbon, glass substrate 2, in a float glass process. Glass substrate 2 is conveyed on rollers 4 in a down-stream direction along a coating path. Glass substrate 2 arrives to the coating section from the tin bath 3 and thus coating is applied between the tin bath 3 and the annealing lehr 9 in the float glass manufacturing process. First coating unit 5 in the coating path sprays a liquid-aerosol on the top surface 10 of glass substrate 2. The coating unit 5 comprises one or more two-fluid atomizers in which liquid flow 6 is atomized by a high-speed nitrogen gas flow 7, the speed of the gas flow at the atomizer tip being typically 50-300 m/s. Also other gases, atomization gases, may be used for atomization. The deposition of the liquid-aerosol process cools the glass substrate surface 10, the surface temperature being schematically presented with curve T. The coating unit 5 thus sprays the liquid-aerosol on the glass substrate surface 10 and a pyrolytic coating is formed. A glass substrate surface heating means 8 is arranged to the coating path after the first coating unit 5. As can be seen from FIG. 1, there is several coating units 5 arranged successively along the coating path and between the coating units there is arranged a glass substrate heating surface means 8. The apparatus 1 may comprise two or more coating units 5 and at least one glass substrate surface heating means 8.

The glass substrate surface heating means 8 may arranged before or after one of the coating units, for example before the first coating unit 5 or after the last coating unit 5. Furthermore a glass substrate surface heating means 8 may arranged between any two coating units 5, and preferably between every successive coating units 5. The glass substrate heating means 8 are arranged to produce a forced convective heating by directing one or more impinging gas jets to the glass substrate surface 10. Thus the glass substrate heating means 8 may comprise one or more gas jets for producing and directing a gas flow towards the glass substrate surface 10. At least one of the glass substrate heating means 8 is arranged to provide a heat transfer at least 10 kW/m² and additionally at least one of the glass substrate heating means 8 is arranged to provide a convective heat transfer coefficient h of at least 100 W/m²K for producing a sufficient heating of the glass substrate surface 10.

The glass substrate surface heating means 8, forced convection unit, may use a high-speed nitrogen-water vapor flow, with the gas temperature being about 650° C. and the gas velocity at the exit of gas jet 8 being 30-200 m/s heating the glass surface as seen from the curve T in FIG. 1. The coating-heating of the glass substrate surface 10 is then repeated until the desired coating thickness is achieved. The coating thickness in producing e.g. transparent conductive oxide (TCO) coatings may be 300-900 nm and in producing e.g. self-cleaning anatase coatings the coating thickness may be 15-50 nm.

The process of the present invention for coating glass substrate 2 by using at least one or more liquid raw materials which react essentially on or in the vicinity of at least a portion of the glass substrate surface 10 forming a coating on it, comprises several steps. First the glass substrate 2, the whole glass substrate, is heated to substantially a coating temperature or at least the annealing temperature of the glass substrate 2. Then a coating is formed on the glass substrate surface 10 by converting the one or more liquid materials to a liquid aerosol and depositing at least a fraction of the liquid-aerosol on the said portion of the glass substrate surface 10. The coating step may be at least once. Before the first coating step, between successive coating steps and/or after the last coating step the glass substrate surface 10 is heated to the coating temperature or to a higher temperature than the glass substrate 2. Accordingly the glass substrate surface 10 heating is carried out by convective heating.

The coating temperature of the glass substrate 2 depends on the provided coating and the properties of the glass substrate. The following coating materials and coating temperatures are disclosed as examples:

| | |
|---|---|
| Antimony doped tin oxide (ATO) | 200-400° C. |
| Indium doped tin oxide (ITO) | 300-400° C. |
| Boron doped zinc oxide | 200-400° C. |
| Fluorine doped zinc oxide | 400-500° C. |
| Aluminum doped zinc oxide (AZO) | 400-500° C. |
| Fluorine doped tin oxide (FTO) | 500-800° C. |
| Titanium dioxide | 500-800° C. |
| Piioxynitridi (SiOxNy) | 500-800° C. |
| Piioxykarbidi (SiOxCy) | 500-800° C. |

The convective heating may carried out before or after the first of the coating step, between at least two coating steps, preferably between every repeated coated step.

It will be obvious to a person skilled in the art that, as the technology advances, the inventive concept can be implemented in various ways. The invention and its embodiments are not limited to the examples described above but may vary within the scope of the claims.

1. A process for coating glass substrate (2) by using at least one or more liquid raw materials which react essentially on or in the vicinity of at least a portion of the glass substrate surface (10) forming a coating on it, the process comprising steps:
a) heating the glass substrate (2) to at least substantially the coating temperature,
b) forming a coating on the glass substrate surface (10) by converting the one or more liquid materials to a liquid aerosol and depositing at least a fraction of the liquid-aerosol on the said portion of the glass substrate surface (10);
c) repeating step b) at least once; and
d) heating the glass substrate surface (10) before at least one of the steps b), characterized in that the glass substrate surface (10) heating in step d) is carried out by convective heating.

2. A process according to claim 1, characterized in that the convective heating step d) is carried out before or after the first of the steps b).

3. A process according to claim 1 or 2, characterized in that the convective heating step d) is carried out between at least two of the steps b).

4. A process according to claim 1 or 2, characterized in that the convective heating step d) is carried out between every repeated step b).

5. A process according to any one of claims 1 to 4, characterized in that the convective heating step d) is a forced convective heating step.

6. A process according to any one of claims 1 to 5, characterized in that the heat transfer in the at least one convective heating step d) is at least 10 kW/m².

7. A process according to any one of claims 1 to 6, characterized in that the at least one convective heating step has a convective heat transfer coefficient h of at least 100 W/m²K.

8. A process according to any one of claims 1 to 7, characterized by heating the glass substrate surface (10) in step d) to substantially the coating temperature or to a higher temperature than the glass substrate (2) heated in step a).

9. A process according to any one of claims 1 to 8, characterized by heating the glass substrate surface (10) to at least 600° C.

10. A process according to any one of claims 1 to 9, characterized by using a two-fluid atomizer for forming the liquid-aerosol.

11. A process according to any one of claims 1 to 10, characterized by atomizing the liquid raw material into droplets with a mean droplet diameter 10 micrometers or less.

12. A process according to any one of claims 1 to 11, characterized by heating the glass substrate (2) in step a) to at least the annealing temperature of the glass substrate (2).

13. A process according to any one of claims 1 to 11, characterized by heating the glass substrate (2) in step a) to at least 100° C., preferably at least 200° C. and most preferably at least 300° C.

14. Apparatus (1) for pyrolytically forming a coating on a glass substrate (2), the apparatus comprising:
conveyor means (4) for conveying the glass substrate (2) in a downstream direction along a coating path;
at least two coating units (5) arranged successively along the coating path for converting one more liquid materials to liquid-aerosol and spraying the liquid-aerosol on the glass substrate (2) to form a coating on the glass substrate (2);
glass substrate heating means (3) for heating the glass substrate (2) to at least substantially the coating temperature of the glass substrate (2) before forming the coating; and
one or more glass substrate surface heating means (8) for heating the glass substrate surface (10),
characterized in that the glass substrate surface heating means (8) are arranged to supply the heat energy to the substrate surface by convection.

15. An apparatus (1) according to claim 14, characterized in that glass substrate surface heating means (8) is arranged before or after one of the coating units.

16. An apparatus (1) according to claim 14 or 15, characterized in that glass substrate surface heating means (8) is arranged between two coating units (5).

17. An apparatus (1) according to claim 14 or 15, characterized in that glass substrate surface heating means (8) is arranged between every successive coating units (5).

18. An apparatus (1) according to any one of claims 14 to 17, characterized in that the glass substrate heating means (8) is arranged to produce a forced convective heating.

19. An apparatus (1) according to claim 18, characterized in that glass substrate heating means (8) comprise one or more gas jets for producing and directing a gas flow towards the glass substrate surface (10).

20. An apparatus (1) according to any one of claims 14 to 19, characterized in that the glass substrate heating means (8) are arranged to heat the glass substrate surface (10) to substantially the coating temperature or to a higher temperature than the glass substrate (2) heated with the glass substrate heating means (3).

21. An apparatus (1) according to any one of claims 14 to 20, characterized in that at least one of the glass substrate heating means (8) is arranged to provide a heat transfer at least 10 kW/m².

22. An apparatus (1) according to any one of claims 14 to 21, characterized in that at least one of the glass substrate heating means (8) is arranged to provide a convective heat transfer coefficient h of at least 100 W/m²K.

23. An apparatus (1) according to any one of claims 14 to 22, characterized in that the coating unit (5) comprises one or more two-fluid atomizers for converting the liquid raw materials to liquid-aerosol.

24. An apparatus (1) according to any one of claims 14 to 23, characterized in that the coating unit (5) is arranged to atomize the liquid raw materials into droplets with a mean droplet diameter 10 micrometers or less.

25. An apparatus (1) according to any one of claims 14 to 24, characterized in that the apparatus (1) is arranged to a glass production line.

26. An apparatus (1) according to claim 25, characterized in that apparatus (1) is located between the tin bath (3) and the annealing lehr (9).
